(19) United States
(12) Patent Application Publication
(10) Pub. No.: US 2026/0320460 A1
(43) Pub. Date: Oct. 15, 2026

(54) SYSTEM AND METHOD FOR AUTOMATIC FINDING OF QUANTUM-DOT CONFIGURATIONS

(71) Applicant: University of Copenhagen, Copenhagen K (DK)

(72) Inventors: Oswin KRAUSE, Copenhagen Ø (DK); Evert VAN NIEUWENBURG, Copenhagen Ø (DK); Anasua CHATTERJEE, Copenhagen Ø (DK); Ferdinand KUEMMETH, Copenhagen Ø (DK)

(73) Assignee: University of Copenhagen, Copenhagen K (DK)

(21) Appl. No.: 19/484,238

(22) PCT Filed: May 30, 2024
(86) PCT No.: PCT/EP2024/064941

§ 371 Date: Nov. 13, 2025

(30) Foreign Application Priority Data
May 30, 2023 (EP) 23176179.2

(51) Int. Cl. G06N 10/40; G06N 3/08

(52) U.S. Cl. CPC G06N 10/40; G06N 3/08

(57) ABSTRACT

A computer implemented method for determining boundary locations of a phase state in a charge stability diagram of capacitively coupled quantum dots includes applying a first voltage vector in the charge stability diagram generated by the coupled quantum dots for defining a first phase state of the coupled quantum dots, determining a phase transition location of the coupled quantum dots from the first phase state to a neighboring second phase state in the charge stability diagram by varying the voltage vector for changing energy levels of the states of the quantum dots until a phase transition occurs, repeating the aforementioned steps for at least a second voltage vector, and fitting the phase transition locations to a plurality of sets of fitting parameters for determining boundary locations of the phase state.

### CROSS-REFERENCE TO RELATED APPLICATIONS

The present application is the national phase entry of International Patent Application No. PCT/EP2024/064941, filed May 30, 2024, which claims priority to European Patent Application No. 23176179.2 filed May 30, 2023, the entire contents of both are hereby incorporated by reference.

### FIELD OF DISCLOSURE

The disclosure relates to a method and a system for automatic and robust estimation of phase boundaries in coupled quantum dots.

### BACKGROUND

A quantum dot electron charge stability diagram, also known as a Coulomb blockade diagram, is a graph that shows the behavior of electrons confined within a quantum dot, a nanoscale structure that can trap and control the motion of individual electrons.

The diagram plots the energy levels of the electrons within the quantum dot as a function of the number of electrons present. Each energy level corresponds to a specific electron configuration within the dot, and the number of electrons can be controlled by applying a voltage to electrodes surrounding the dot.

The Coulomb blockade diagram is used to study the electrical properties of quantum dots, including their electronic transport and charge storage capabilities. These diagrams are particularly useful in the field of quantum computing, where quantum dots are being investigated as potential building blocks for qubits, the basic units of quantum information.

Charge stability diagrams are a tool used to analyze the behavior of quantum dots, which are small regions of a material that can trap and control the motion of individual electrons. In a charge stability diagram, the number of electrons in the quantum dot is plotted as a function of two control parameters, typically the voltage applied to nearby electrodes.

Spin qubits, on the other hand, are quantum bits that encode information in the spin states of individual electrons. In some types of spin qubits, the qubit is created by confining a single electron in a quantum dot and using the spin of the electron as the qubit. To manipulate the spin of the electron, magnetic fields are applied to the quantum dot, which can cause the spin to precess or rotate.

Charge stability diagrams can be used to study the behavior of spin qubits by providing a way to map out the regions of the diagram where the number of electrons in the quantum dot is stable. By understanding how the number of electrons in the quantum dot changes in response to changes in the control parameters, researchers can better design and control the behavior of the spin qubit.

For example, researchers can use charge stability diagrams to determine the optimal range of voltages to apply to nearby electrodes for confining a single electron in the quantum dot. They can also use the diagrams to identify regions where the electron spin is particularly stable, which can be useful for encoding and manipulating qubit information.

The dimension of charge stability diagrams depend on the number of quantum dots, the number of electrodes nearby the quantum dots acting as qubit gates and the coupling between the quantum dots. Typically, in a state of the art quantum dot circuit for performing quantum transport experiments, the number of dimensions is higher than the common 2D charge stability diagrams used to visualize data. The precise navigation between different quantum dot configurations in said multi-dimensional diagram is not obvious and requires a big computational power, due to the high number of intercorrelated variables and the different possible paths available in the high dimension space. The complexity in the characterization of these multi-dimensional diagrams slows down the development and improvement of real quantum dot devices, which is considered as a bottle neck in the field.

In summary, charge stability diagrams provide a useful tool for studying the behavior of quantum dots, which can be used as a platform for implementing spin qubits. By understanding the behavior of the quantum dots, researchers can better design and control the behavior of spin qubits for applications in quantum computing and other areas of quantum technology.

Considering the prior art described above, it is an object of the present disclosure to provide a solution for analysing and manipulating a plurality of quantum dots. As the systems that are trying to realize quantum computing evolve, the number of quantum dots that are used also scales up. As a result, it can be challenging for a researcher to the traditional method of manually analyzing and interpreting the charge stability diagrams of N number of quantum dots, especially when N is large like N>4 or N>5.

### SUMMARY

The object can be achieved by a computer implemented method for determining boundary locations of a phase state in a charge stability diagram of capacitively coupled quantum dots. The method comprises an initial step of applying a first voltage vector in the charge stability diagram generated by the coupled quantum dots for defining a first phase state of the coupled quantum dots. Thereafter, the method comprises an additional step of determining a phase transition location of the coupled quantum dots from a first phase state to a neighboring second phase state in the charge stability diagram by varying the voltage vector for changing energy levels of the states of the quantum dots until a phase transition occurs. By repeating the two steps for at least a second voltage vector, a final step of fitting the phase transition locations to a plurality of sets of fitting parameters for determining boundary locations of the phase state is performed. From the plurality of sets of fitting parameters, at least one set of the plurality of sets of fitting parameters can be a set of non-linear fitting parameters, wherein the non-linear fitting parameters preferably are extracted by means of a machine learning model, such as a deep neural network. Utilizing a set of non-linear fitting parameters may enable the fitting of realistic coupled quantum dot charge stability diagrams, where tunneling effects are apparent, leading to curved phase transition locations.

The way that the phase transitions can be identified is by recording the conductance of the device as a function of the applied voltages. Specifically, the method may be configured to determine that a differential conductance of less than 20% of 2e²/h is measured inside a first phase state or a second phase state in the charge stability diagram, while a differential conductance of at least 70% of 2e²/h may be measured during a phase transition from the first phase state or from the second phase state in the charge stability diagram. Using these approximate value ranges of conductance, the method can differentiate between a phase state and a phase transition. Specifically, in various experiments it might be beneficial to investigate the ratio between the differential conductance inside the first or the second phase state and the differential conductance during a phase transition from the first phase state or from the second phase state. That ratio could be in the order of around 0.1.

Thus, it is possible to use this method to automatically resolve the phase boundaries of any given state of a coupled quantum dots system. In an embodiment, it is possible to perform the method by starting on the (0,0) state, meaning the charge state where two coupled quantum dots each have zero electrons. The voltage variation for changing energy levels of the states of the quantum dots may be applied varying one voltage of the voltage vector in the charge stability diagram, or said voltage variation may comprise the voltages of a plurality of electrodes that control and define the capacitively coupled quantum dots. This process may be repeated at least 10 times, more preferably at least 50 times, even more preferably at least 200 times, until the phase boundaries of the studied state are determined.

Moreover, the above process can be conducted in different initial states, such as (0,1), (1,0) resulting into the mapping of a larger area of the charge stability diagram.

In summary, the present disclosure provides researchers a useful tool for determining the phase boundaries of coupled quantum dots by applying voltage vectors to identify phase transitions, and the present disclosure is capable of automatically fitting these transitions to map out the charge stability diagram. In conclusion, it is possible to estimate the multi-dimensional phase boundaries of complex coupled quantum dot systems with varied tunnel and capacitive couplings, by using a robust and accurate machine learning model.

The disclosure also relates to a computer program comprising instructions which, when the program is executed by a computing device or a system, cause the computing device or the system to carry out the steps of the method.

The disclosure also relates to a computer-readable medium comprising stored instructions which, when executed by a computing device or a system, cause the computing device or the system to carry out the steps of the method, wherein the computing device or the system may be connected to a cryostat comprising a plurality of coupled quantum dots for controlling voltages of electrodes of the cryostat for defining and controlling the plurality of coupled quantum dots.

### DEFINITIONS

Charge stability diagram: A charge stability diagram of a coupled quantum dot can be understood by the person skilled in the art as areas of suppressed conductance, interrupted by areas of higher conductance, also known as boundary locations, transition lines or parity lines. At the boundary locations, current can flow through a quantum dot, leading to increased conductance on the boundary location. In the rest of the charge stability diagram, suppressed conductance is a sign of Coulomb blockade in the coupled quantum dot.

### BRIEF DESCRIPTION OF THE DRAWINGS

FIG. 1 An example of a charge stability diagram of coupled quantum dots.

FIG. 2 The same charge stability diagram as in FIG. 1, illustrating various voltage vector for adding electrons in the quantum dots or shuffling electrons between the quantum dots.

FIG. 3 A flowchart example of the functioning algorithm method for determining polytope facets in charge stability diagram of coupled quantum dots.

FIG. 4 The same charge stability diagram as in FIG. 1, highlighting the learned polytope of a simulated device without tunneling.

FIG. 5 An example of a charge stability diagram of a coupled double quantum dot, showing a learned polytope for a device with finite tunneling between the quantum dots.

### DETAILED DESCRIPTION

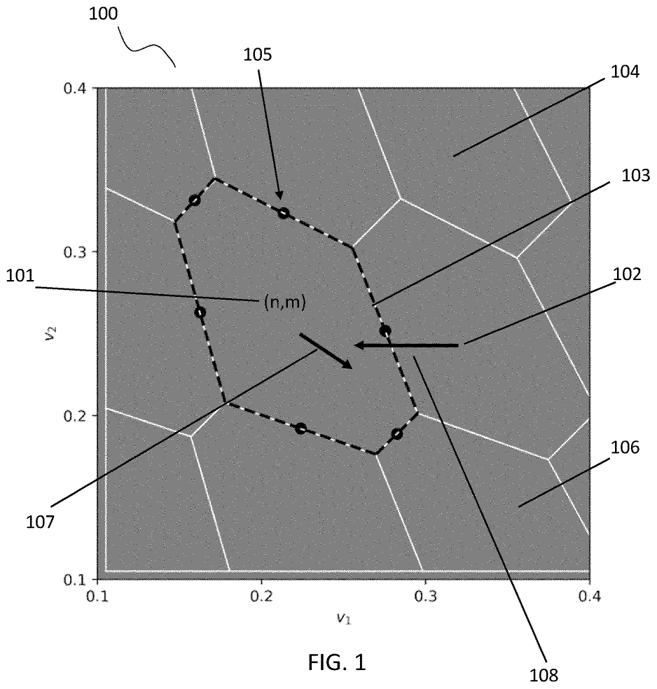

The present disclosure relates to a computer implemented method for determining boundary locations of a phase state in a charge stability diagram of capacitively coupled quantum dots. An example of a charge stability diagram (100) comprising a first phase state (n,m) (101), a second phase state (102), and a third phase state (106) is shown in FIG. 1. The method comprises an initial step a) of applying a first voltage vector in the charge stability diagram generated by the coupled quantum dots for defining a first phase state of the coupled quantum dots.

It is understood as voltage vector to a series of voltage values, wherein each value denotes the voltage applied to each of the electrodes used to define and manipulate the quantum dots. For example in a system comprised by two quantum dots, a voltage vector V₀:(v1, v2)=(0.25, 0.25) may be applied within the first phase state (101), as shown in FIG. 1 to define the first phase state (n,m) wherein n is the number of electrons on one quantum dot and m the number of electrons on the other quantum dot. The voltage vector can either have an origin at V_{Origin}=(0,0), or it is also possible to consider V₀ as an initial voltage point, from where the first phase state is defined and the following steps can be executed.

Then, the second step b) would be to determine a phase transition location of the coupled quantum dots from the first phase state (n,m) to a neighboring second phase state in the charge stability diagram by varying the voltage vector for changing energy levels of the states of the quantum dots until a phase transition occurs. For example, starting from V₀, by applying a voltage vector (102) V₁:(v1′, v2)=(0.35, 0.25) and continuously measuring the differential conductance as the voltage changes from V₀ to V₁, it would be possible to record the phase transition (103). By repeating the above steps for at least a second voltage vector, and fitting the phase transition locations to a plurality of sets of fitting parameters, it is possible to determine boundary locations of the phase state (103). For example, as seen in FIG. 1, it would be possible to map out the whole polygon (black dashed line) by picking additional voltage vectors in different directions, and recording the different phase boundaries for each facet. Specifically, from the plurality of sets of fitting parameters, at least one set of the plurality of sets of fitting parameters may be a set of non-linear fitting parameters extracted by means of a machine learning model, such as a deep neural network. The term extracted may also be understood as optimizing the plurality of sets of fitting parameters in order to fit the phase transition locations, or as producing a plurality of sets of fitting parameters in order to fit the phase transition locations. The machine learning model may comprise the plurality of sets of fitting parameters, which can be optimized and then extracted, in order to fit the phase transition locations, and determine the boundary locations of a phase state. For example, a machine learning model may be used to produce linear and/or non-linear fitting parameters, said fitting parameters may then be used to fit the phase transition locations in a charge stability diagram. The non-linear fitting parameters may be used to describe deviations from the constant interaction model. For example, if a coupled quantum dot system has significant tunneling between the two quantum dots, the phase transition locations will develop rounding features, which require the use of non-linear fitting parameters in order to be fitted. Further details about the non-linear fitting parameters and the machine learning model are provided in the later sections of the present disclosure.

In an embodiment, the method may comprise the step wherein the initial random voltage point is sampled inside a phase state such as the phase state (0,0). This phase state would be the state where zero electrons occupy both of the coupled quantum dots. This choice could be beneficial for researchers as a starting state, since it is easier to understand and interpret. That occurs because the more electrons that are added in a quantum dot, the more complicated the system might be, as in some cases the electron-electron interactions in the quantum dot can create anomalies in the charge stability diagram. It may also be possible to have the initial voltage point inside another state which would be in the few electron regime. In that regime, it may be easier than for a multi electron regime for the model to fit the phase boundaries as the electron-electron interactions can be limited.

Moreover, in an embodiment the method can comprise the step wherein the second voltage vector is applied for defining a second initial random voltage point sampled inside the first phase state. For example, it may be useful to pick voltage vectors that is positioned within the same state (107), as this can be used as a calibration tool, since the recorded conductance should remain in the same order of magnitude. This may be a process that is automatically performed by the model in an initial series of measurements, to calibrate the value of conductance recorded.

Regarding the voltage manipulation, the method can comprise the step wherein the step of varying the voltage vector is applied varying one voltage component of the voltage vector in the charge stability diagram. For example, one may start from the voltage vector V₀:(v1, v2)=(0.25, 0.25) (FIG. 1) and by changing the voltage of the electrode v1, it is possible to form a voltage vector V₁:(v1′, v2)=(0.35, 0.25) (FIG. 1 (102)), such that only the v1 voltage has changed.

On the other hand, the method can comprise the step wherein components of the vector voltage are voltages of a plurality of electrodes that control and define the capacitively coupled quantum dots. For example, starting from the voltage vector V₀:(v1, v2)=(0.25, 0.25) (FIG. 1 (101)) and by changing the voltage of the electrodes v1 and v2, it is possible to form a voltage vector V₂:(v1′, v2′)=(0.35, 0.35) (FIG. 1 (104)), such that the v1 and v2 voltages have changed.

The above voltage vectors can be performed a plurality of times. Specifically, the method comprises the step wherein the steps a) and b) are performed at least 10 times, preferably at least 50 times, more preferably at least 200 times. For example, in FIG. 1 (105) the black dots relate to six locations of phase transitions in a given state, one for each side of the polygon. This would be a minimum number used to determine the phase transitions of a given state, but ideally more phase transition locations are preferred, to extract a higher resolution schematic of the state. If for a given device the coupled quantum dots have at least one small (in hypersurface) facet, the steps a) and b) may need to be performed enough times in order to accurately reproduce the polygon.

In addition, the method may comprise the step wherein the steps a) and b) are performed in initial random voltage points located at a second phase state in the charge stability diagram. For example, for the determination of the phase transitions of the state (n,m) in FIG. 1, instead of starting from the voltage vector V₀:(v1, v2)=(0.25, 0.25) (FIG. 1 (101)) and then performing the vector for identifying the phase transitions, it is also possible to start from V₁:(v1′, v2)=(0.35, 0.25) (FIG. 1 (102)), and then identify phase transitions (108).

Regarding the differential conductance, the method can comprise the step wherein a differential conductance is less than 20% of 2e²/h inside the first phase state or the second phase state in the charge stability diagram. This would refer to the fact that the differential conductance is usually suppressed in a quantum dot, as long as the voltage location of the recorded differential conductance is not on the phase transition. Therefore, by measuring values less than 20% or less than 30% of 2e²/h the method can safely determine that the location of the measurement relates to a location inside a phase state. In addition, the method can comprise the step wherein a differential conductance is at least 70% or at least 80% of 2e²/h during a phase transition from the first phase state or from the second phase state in the charge stability diagram. For example, if the voltage vector leads to the dashed lines in FIG. 1 (103), where these points reflect phase transitions, it is known that the differential conductance is higher, and possibly approximately of 70% of 2e²/h. With this knowledge, the method can determine that locations with that value of conductance are related to locations of a phase transition.

In another embodiment, the method can comprise the step wherein the ratio between the differential conductance inside the first or the second phase state and the differential conductance during a phase transition from the first phase state or from the second phase state is less than 0.8, preferably less than 0.6, more preferably less than 0.4, even more preferably less than 0.1, most preferably around 0.05. It can be useful to identify the ratio between the two conductances, because each device is unique due to fabrication differences that can lead to changes in the device. As a result, this may lead to different coupling rates between electrodes and quantum dots, or to different sizes of quantum dots due to changes in the lithography techniques. However, even though changes from device to device might occur, the difference in the order of magnitude in the differential conductance inside a phase state and in a phase transition for a given device should be significant. Therefore, it can be beneficial for the present disclosure to be able to record such ratios. Furthermore, the differential conductance may be recorded instead of conductance, because the differential conductance is experimentally an easier task, as the differential conductance can be measured while there is no application of a finite direct-voltage bias across the device, and because the differential conductance does not distort the charge stability diagram measurements and the fitted result.

### Fitting Model for Determining Phase Transitions

In order to perform all the above automatically, a fitting algorithm has been developed which is described below. The machine learning model of the Coulomb diamond with electron configuration n may have the general form:

$$m ( υ ) = log {\sum }_{k = 1}^{M} exp ( {f}_{k} ( Φ ( υ ) ) ) \qquad ( 1 )$$

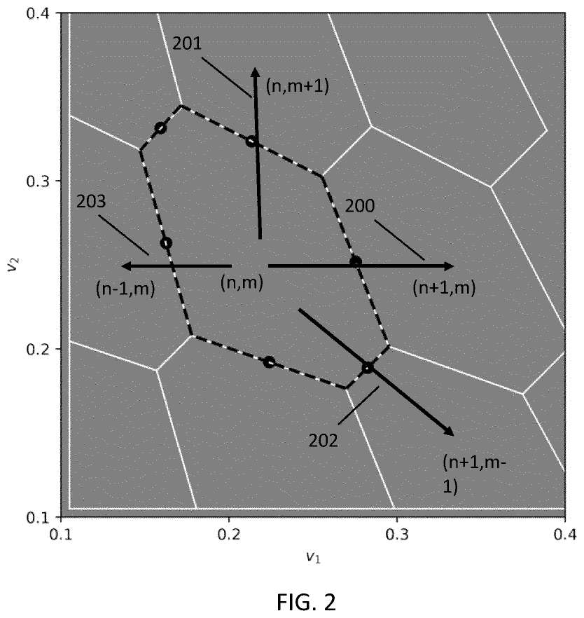

Here, fₖ are M linear functions that are intended to learn the transition of interest and m(υ) computes a probability for each voltage u whether each voltage υ is part of the Coulomb diamond or not. To generate fₖ, the user enumerates the list of transitions they wish to learn and chooses a transition vector tₖ. This transition vector describes the changes in occupation of the individual quantum dots when crossing a facet. The set of transitions include all transitions that are likely big and which need to be learned. These are usually the transitions that add or remove single electrons as well as transitions that shuttle electrons between neighboring dots. For example, moving along the trajectory shown in FIG. 2 (200) an electron is added on one quantum dot, along the (201) trajectory an electron is added on the second quantum dot, and along the (202) trajectory an electron is moved from one quantum dot to the other. Additionally the user can add further small transitions that are of special interest. However, the list does not need to be exhaustive as the algorithm can deal with small transitions that are not part of the model. The equation fₖ can be written as:

$${f}_{k} ( υ ) = {w}_{k}^{T} υ + {b}_{k} \qquad ( 2 )$$

wherein

$${w}_{k}^{T}$$

can comprise a set of linear terms depending on the transition vector tₖ.

In an embodiment, the method may comprise the step wherein, at least one set of the plurality of sets of fitting parameters is a set of linear fitting parameters. For example, in the equation (2) written above, the voltage u is multiplied with the parameter

$${w}_{k}^{T} ,$$

which can comprise various linear parameters. The method may comprise an additional step wherein the fitting of the at least one set of linear fitting parameters is performed by a machine learning model. For example, the linear fitting parameters within

$${w}_{k}^{T}$$

can be fitted by a machine learning model. Using such a model may further increases the performance of the method, as the model can provide accurate solutions within a shorter time frame compared to conventional fitting models.

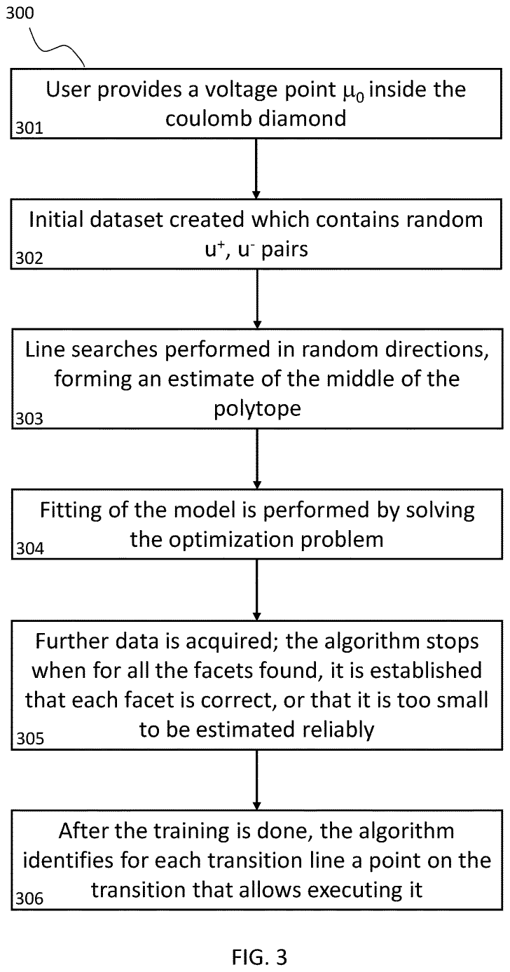

To further enhance the performance of the method, the method can comprise the step wherein the machine learning model is trained with training data. Such an example can be seen in FIG. 3, where a process flow for the algorithm is illustrated (300). Initially, the user may provide an initial voltage point pa which would lie inside a coulomb diamond (301). An initial dataset is created by taking a user supplied point po. The dataset may contain random point pairs u⁺, u⁻ (302), wherein the algorithm assumes that the data points u⁺ are inside the polytope, while the data points u⁻ are outside. Then, the method may proceed to create line searches in random directions around that point, computing a better estimate for the middle of the polytope (303). The model can be then fit by solving the optimization problem (304). Further data can be acquired, and the stopping criterion can be computed (305). The stopping criterion of the algorithm is based on a check that for all the facets the algorithm found, it is either established that the facet is correct, or that it is too small to be estimated reliably with the line-search precision available. Finally, after the training is done, the algorithm can identify for each transition line a point on the transition that allows executing the method (306). As an example, it is possible to pick as the initial voltage point the mean (or median) of the point pairs that the algorithm identified to be separated by a given boundary. The transition can be queried by performing a voltage ramp from μ (comprising of pair u⁺, u⁻) through a point on the given boundary to the target neighboring state.

In addition, the method may comprise the step wherein the training data comprises locations and/or orientations of phase transitions of known charge stability diagrams. For example, in the process described above (300), the user-provided points may also comprise more detailed data points which may be located close to phase transitions or on phase transitions. These points may assist in extracting the slope of each phase transition, which may give information for the capacitive coupling of the gate electrodes to the quantum dots. Hence, this information may be useful for the function of the model.

The machine learning model may also be configured to calculate differences between the measured locations and measured orientations of phase transitions and from an ideal constant interaction model of a capacitively coupled quantum dot system. As is shown in FIG. 1, the boundary transitions of the quantum dots are not perfectly perpendicular or horizontal to the v1,v2 axis. This shows that there is a finite cross-capacitive coupling between each electrode and each quantum dot, and that real data cannot be fully interpreted by the ideal constant interaction model. Therefore, it is useful for the model to account for this capacitive coupling and the non-ideal parameters, and the model can achieve that by utilizing terms in the model (2) to account for that. For example, one term may be used to be the same as in the constant interaction model, while other terms can capture parts of the error that capacitances change. These parameters may allow to model the error for the facets that add or remove a single electron from a quantum dot. The above parameters may also be utilized to further configure the machine learning model to calculate deviations between measured phase transition boundaries and phase transition boundaries calculated by an ideal constant interaction approximation. As the model may account for changes in the slopes of the phase transition boundaries, it may also reduce the error in calculating their positions in real devices.

Moreover, the method may comprise the step wherein the at least one set of the linear fitting parameters describe the boundary location of the phase state for an electron addition in the initial phase state into the neighboring phase state.

In addition, the method may comprise the step wherein at least one set of the linear fitting parameters describe the boundary location of the phase state for an electron removal from the initial phase state. For example, the model described above (2) may have transition vectors tₖ which can take values −1, 0 and 1. For a value tₖ=1, that would reflect the addition of an electron to a quantum dot. On the other hand, for tₖ=−1, that would mean that an electron is removed from a quantum dot. Such transitions can also be seen in FIG. 2 (200,203) where an electron is added or removed from a quantum dot. Furthermore, the method can comprise the step wherein at least one set of the linear fitting parameters describe the boundary location of the phase state for transporting an electron from one of the coupled quantum dots to the other coupled quantum dot. An example of such a process (202) can be seen in FIG. 2, where a voltage vector is used to add an electron to one quantum dot (n+1) and remove an electron from the other quantum dot (m−1) effectively transporting an electron from one quantum dot to the other. It may be beneficial for the method to have such fitting parameters that can describe those boundary locations, as these transitions are a part of the coupled quantum dot polytopes, and as they may have different slopes to the other boundary locations, it is useful to have fitting parameters dedicated for them.

The method may comprise the step wherein at least one set of the plurality of sets of fitting parameters is a set of non-linear fitting parameters. For example, on the equation described above

$${f}_{k} ( υ ) = {w}_{k}^{T} υ + {b}_{k} , \qquad ( 2 )$$

a set of non-linear fitting parameters can be included, which can assist in fitting non-linear data. For example, fₖ(σ) can be described as fₖ(Φ(υ)), where Φ(υ) is a non-linear function, comprising of non-linear terms. In an embodiment, Φ(υ) can be:

$$Φ ( υ ) = ( \frac{υ - μ}{‖ υ - μ ‖} ) \cdot ( υ - μ ) + μ$$

The function s(⋅) is a non-linear fitting parameter. If the function s(⋅)=1, then the function obtains φ(υ)=υ. That case would correspond to a coupled quantum dot having infinitely weak tunneling between the quantum dots, leading to an absence of curved transition lines in the charge stability diagram.

Otherwise, voltage points u that lie on the line μ+t·p for some t>0, get scaled by some factor s(p) to the position υ′=μ+ts(p)·p. The effect is that the convex polytope gets warped. The function s can be any machine-learning model. In an embodiment, the function s can be a machine-learning model that can accept vectors of length 1. This could for example be neural networks or kernel expansion models. Therefore, the above use of the non-linear parameter s in the function Φ(υ), allows the method described in the present disclosure to successfully model coupled quantum dots that have visible tunneling effects in their corresponding charge stability diagram (i.e. warping of charge stability diagram), resulting in non-linear boundary locations of phase states. Hence, using such non-linear fitting parameters can enable the fitting of charged stability diagrams with curved boundary locations.

For example, the non-linear fitting parameter s(p) can be described as:

$$s ( p ) = exp ( {\sum }_{ì = 1}^{K} {α}_{i} k ( p , {q}_{i} ) )$$

Where k is a periodic kernel function, qᵢ are basis direction which are used to learn corrections of the voltage points, and αᵢ are learnable parameters. Such a function comprises non-linear fitting parameters, such as q₁ and αᵢ. which may be used to model a charge stability diagram with significantly rounded corners.

The method may further comprise the step, wherein the set of non-linear fitting parameters is extracted by means of a machine learning model and/or a non-linear model, such as a deep neural network. For example, the s( ) function shown above can be provided by a neural network, and the s( ) function can—along with the other fitting parameters—be used to fit the phase transition locations of a charge stability diagram. Further information regarding non-linear parameters is provided in the examples section. As described above, the advantage of the non-linear parameters is the method can determine the boundaries of a phase state having curved boundaries.

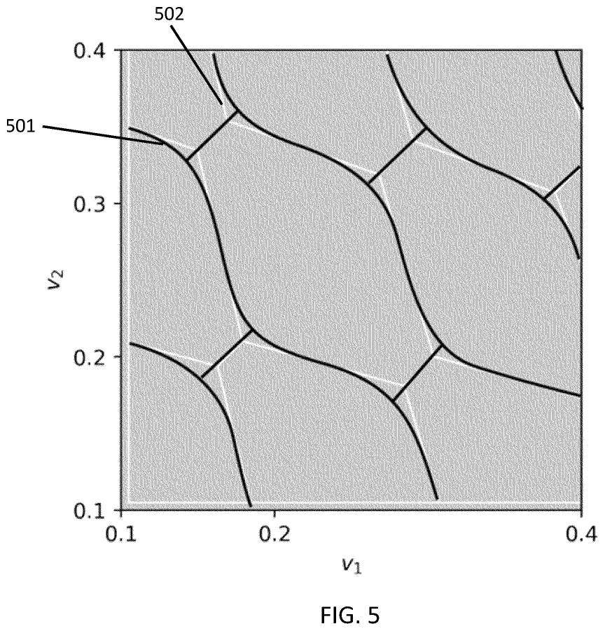

Furthermore, the method may be configured such that the at least one set of non-linear fitting parameters are used for determining the boundary location(s) of the phase state. This feature may be beneficial, as in some cases the boundary locations of the phase states are not perfectly straight lines, but they have a certain curvature. This can occur, if the wave functions of the quantum dots overlap, and mixing of the states of the two quantum dots occur. In that case, hybridization of the quantum dots can cause a certain bending of the shape of the phase transition lines. In addition, the method may comprise the step wherein the non-linear fitting parameters accommodate tunneling effects between coupled quantum dots. One way of accommodating for the tunneling effects is to consider that the coulomb diamond of interest has some center μ and as the polytope is roughly convex, all its transitions can be reached by the intersection of a line starting from μ in the direction of the transition. In a coupled quantum dot, tunneling effects between the two quantum dots, also known as inter-dot tunneling, can create roundness effects in the boundary locations. Then, it may be possible to model the roundedness by a scaling factor that scales this intersection point to align with the learned polytope in the direction. An example of such a model using the above features can be seen in the examples section of the application, where a φ(υ) function, as the one described in the previous section, may be used, comprising non-linear terms, in order to fit such a polytope with curved boundary locations. Such a model can effectively scale the fitted boundary locations of a phase state by a factor, leading to the convex polytope to get warped. That function may be any machine-learning model that can accept vector of length 1. That can be for example neural networks or kernel expansion models. An example showing a simulation of a device with warped corners can be seen in FIG. 5, where a charge stability diagram of a coupled double quantum dot is shown. Significant tunneling is present between the coupled quantum dots, evident by the curved boundary locations 501. In order to highlight the effect that tunneling between the coupled quantum dots may have, a simulation of a coupled quantum dot with no tunnelling between the dots is superimposed 502 on the curved boundary locations. Therefore, in order to properly fit coupled quantum dot, it is important to incorporate non-linear fitting parameters in the model.

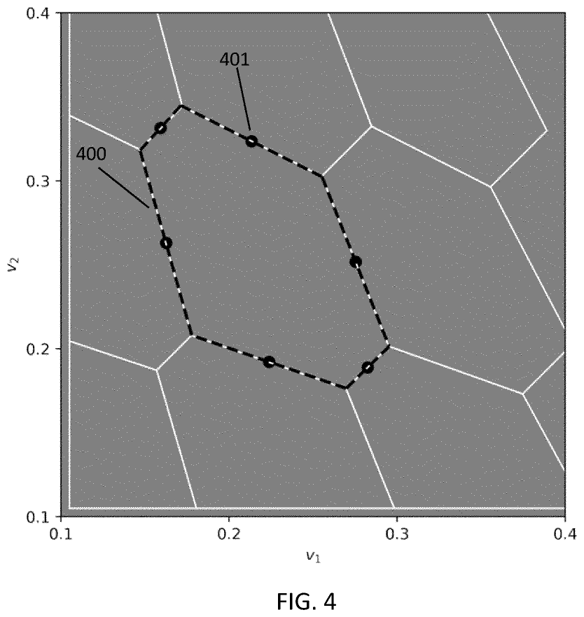

In another embodiment, the method may further comprise the step, wherein the boundary locations reconstruct a fitted polytope and state labels of the capacitively coupled quantum dot devices according to the fitted sets of fitting parameters. An embodiment of this can be seen in FIG. 4, where the steps of the model described in the previous paragraphs have been implemented and a fitted polytope has been identified as the black dashed lines (400). In this embodiment, the black dots (401) are the found transition points from the final step of the algorithm introduced above, which can be used to execute a transition which can be queried by performing a voltage ramp from the central part of the coulomb diamond, through the identified points to the target neighboring states. The benefit of this additional step is that the trained model may be fully automatic, preferably without the assistance of any human operator.

The method can comprise the step, wherein a voltage line-scan is performed after measuring a boundary location of the phase state into a neighboring phase state, until a new boundary location of the phase state is measured. As described above, this process can be performed by picking a voltage vector starting from the middle of a coulomb diamond, and passing through the transition boundaries towards neighboring states. This may be a useful tool, in order to verify the positions of the phase boundaries of a given state, but also to investigate additional coulomb diamonds and possibly explore potential changes in the neighboring states, such as coupling changes between the two quantum dots.

The method may comprise an additional step wherein the fitting and reconstruction of the phase state is performed starting at the midpoint of the line-scan of the random voltage point is sampled inside a phase.

The method can comprise the step, wherein the fitted polytope has a dimension>3. For example, if the system is extended to accommodate a plurality of quantum dots, then the charge stability diagram would not only have two axis, but it would require more electrode voltages to describe each polytope. Therefore, the dimension of the fitted polytopes can depend on the number of the coupled quantum dots, and the corresponding number of the electrodes that control them.

Hence, the dimension of the polytope to be determined is set by the experimental setup and known before performing the method herein disclosed. On the other hand, the precise number of transition boundaries is not known a priori. The transition boundaries regarding location, arrangement, length and neighboring electron states, which the present method is to determine, are affected by the experimental characteristics of the quantum dots. For example, nano-fabrication inhomogeneities of the quantum dots, noise in the experimental setup or the uncertainty of the measured and applied voltages might have an influence in the number, location and/or length of the facets of the polytope. Accordingly, the machine learning and deep neural network models need to be trained with data from known transition boundaries in order to estimate the location of the boundaries that describe the polytope under study. The known transition boundaries can e.g. be determined by the traditional method of manually determining the change of the charge state, where the known transition boundaries may be used as the result for the machine learning model or the deep neural network model and where the found phase transition locations of the coupled quantum dots based on the present method may be used as input for the machine learning model or the deep neural network model. The dimension of the polytope may also be an input for the machine learning model or the deep neural network model.

The present disclosure can further comprise a computer program comprising instructions which, when the program is executed by a computing device or a system, cause the computing device or the system to carry out the steps of the method of any of steps described above. The computer program may be stored on any suitable type of storage media, such as a non-transitory storage media.

The present disclosure can comprise a computer-readable medium comprising stored instructions which, when executed by a computing device or a system, cause the computing device or the system to carry out the steps of the method described on any of the above paragraphs.

The present disclosure further relates to a system for determining boundary locations of a phase state in a charge stability diagram of capacitively coupled quantum dots, the system comprising a processor and a memory and being configured to carry out any one of the steps of the method of any one of the preceding paragraphs.

The present disclosure may further relate to a system for determining boundary locations of a phase state in a charge stability diagram of capacitively coupled quantum dots, the system comprising a plurality of sources, such as voltage sources, for controlling a plurality of electrodes connected to the capacitively coupled quantum dots, wherein the system is configured to apply a first voltage vector in the charge stability diagram generated by the coupled quantum dots for defining a first phase state of the coupled quantum dots, determine a phase transition location of the coupled quantum dots from the first phase state to a neighboring second phase state in the charge stability diagram by varying the voltage vector for changing energy levels of the states of the quantum dots until a phase transition occurs, repeat the steps a) and b) for at least a second voltage vector, and fit the phase transition locations to a plurality of sets of fitting parameters for determining boundary location(s) of the phase state.

In an embodiment, the system may comprise an input interface for obtaining data of a charge stability diagram, and/or an output interface for outputting the fitted phase transition locations of the charge stability diagram.

Moreover, the system can be configured, such that the system is connected to a cryostat for accommodating the coupled quantum dots and the plurality of electrodes. For example, the system can be connected to a cryostat which has a device installed on it. The device may have any number of quantum devices, such as coupled quantum dots. The device can be connected with transmission lines to external voltage, current and/or high-frequency signal sources for controlling the voltages of the various electrodes and gates on the device.

In an embodiment, the system may be configured for automatically controlling the signals to the plurality of electrodes of the cryostat for defining and controlling the plurality of coupled quantum dots, thereby enabling automatic determination of boundary locations of a phase state in a charge stability diagram. For example, the system may be connected to the external voltage, current and/or radio-frequency signal sources in order to control the sources, and probe the device according to the plan of a user. It may be possible that the system can automatically control all the sources, such as voltage sources, and characterize coupled quantum dot devices by determining the boundary locations of phase states in a charge stability diagram. The system may also tune the device to different coupling regimes and identify the boundary locations of phase states in different configurations. A user may also control the sources if needed, in order to select a specific coupling regime, or in order to tune the device in a different configuration.

Moreover, the system can be configured, such that the plurality of sources are selected from the group of: voltage sources, current sources, or radio-frequency sources. Depending on the type of an experiment, different types of sources, or probes, can be utilized, as different types of measurements are suitable for different experiments or specific tasks. For example, the voltage sources can be any kind of DC or AC voltage sources, such a digital-to-analog (DAC) voltage sources. The voltages applied may vary from −50 mV to 50 mV, in steps of as small as nV. In certain situations, voltages of up to 50 V may be applied, on certain electrode types. In various cases, voltage dividers may also be used in order to tune the voltage that reaches the device. Depending on the type of coupled quantum dots, different voltage ranges or steps may be used. Various current sources may be used, such as in four-terminal measurements, or current-bias measurements, where a current signal can be sent to a coupled quantum dot, and a conductance or voltage measurement can be performed.

For example, the step of determining a phase transition location of the coupled quantum dots from the first phase state to a neighboring second phase state in the charge stability diagram by varying the voltage vector for changing energy levels of the states of the quantum dots until a phase transition occurs, can be performed by detecting changes in current or in differential conductance.

In an embodiment, high-frequency measurements may be set up, where radio signals can be used as probes for the various electrodes of the device. Such high-frequency measurement have the advantage of being time-efficient, leading to measurements that can be conducted at a higher speed in contrast to DC measurements. For example, if the system operates on a plurality of coupled quantum dots, radio-frequency signals may be preferred to probe the devices, as they can significantly lower the measurement time of estimating the boundary locations of phase states.

The system may further comprise peripheral components such as one or more memories, which may be used for storing instructions that can be executed by any of the processors. The system may further comprise internal and external network interfaces, input and/or output ports, a keyboard or mouse etc. As would be understood by a person skilled in the art, a processing unit also may be a single processor in a multi-core/multiprocessor system. Both the computing hardware accelerator and the central processing unit may be connected to a data communication infrastructure.

The system may include a memory, such as a random access memory (RAM) and/or a read-only memory (ROM), or any suitable type of memory. The system may further comprise a communication interface that allows software and/or data to be transferred between the system and external devices. Software and/or data transferred via the communications interface may be in any suitable form of electric, optical or RF signals. The communications interface may comprise, for example, a cable or a wireless interface.

In an embodiment, the system can be configured, such that the cryostat comprises a temperature control channel and a magnet, the magnet configured to generate a magnetic field, wherein the system controls the temperature control channel and the magnet. For various experiments related to coupled quantum dots, further information can be extracted by modifying the temperature of the coupled quantum dots, or by applying a magnetic field. It is known in the state of the art, that modifying temperature and/or magnetic field leads to changes in the charge stability diagram of a coupled quantum dot. Therefore, it may be possible to modify the temperature and the magnetic field in order to fit the phase transition locations of the coupled quantum dot, and correlate the changes of the charge stability diagram to the changes of the temperature and/or magnetic field.

In an embodiment, the system can comprise an interface and/or display for obtaining the boundary location(s) of the phase state. Such an interface or display may be utilized by a user, in order to visualize the results of the fitting.

In addition, the system can be configured to carry out any one of the steps of the method of any one of the preceding paragraphs.

### EXAMPLES

An embodiment of the present disclosure relates to a model that is used to estimate the phase boundaries of a coupled quantum dot system. Specifically, a machine-learning model that is intended to be able to learn the rounded polytope of a real device can be utilized. The machine learning model of the Coulomb diamond with electron configuration n can have the general form:

$$m ( υ ) = log {\sum }_{k = 1}^{M} exp ( {f}_{k} ( Φ ( υ ) ) )$$

Here, fₖ are M linear functions that are intended to learn the transition of interest and m(υ) computes a probability for each voltage υ whether each voltage υ is part of the coulomb diamond or not. To generate fₖ, the user enumerates the list of transitions they wish to learn and chooses a transition vector tₖ, where can take a value −1, 0, 1. For a value tₖ=1, that would reflect the addition of an electron to a quantum dot. On the other hand, for tₖ=−1, that would mean that an electron is removed from a quantum dot. The set of transitions should include all transitions that are likely big and which need to be learned. These are usually the transitions that add or remove single electrons as well as transitions that shuttle electrons between neighboring quantum dots. Additionally, the user may add further small transitions that are of special interest. However, the list does not need to be exhaustive as the algorithm can deal with small transitions that are not part of the model. fₖ can then be written as:

$${f}_{k} ( υ ) = {\underbrace{{c}_{k} ( {t}_{k}^{T} A + {t}_{k , > 0}^{T} {A}^{+} + {t}_{k , < 0}^{T} {A}^{-} )}}_{{w}_{k}^{T}} υ + {b}_{k}$$

Where the vectors t_{k,>0} (t_{k,<0}) are obtained from tₖ by setting to zero all elements of tₖ that are smaller than zero (bigger than zero). cₖ is a single positive scalar. Its effect in the model is to represent a measure of certainty for the transition fₖ to be correct. The worse the fit of the model, the smaller typically cₖ gets.

The first

$${t}_{k}^{T} A$$

is the same as in the constant interaction model, while the latter two terms capture parts of the error that capacitances change. This model allows to exactly model the error for the facets that add or remove a single electron from a dot. These are typically the largest facets on the coulomb diamond, and thus the errors introduced by the change of normals are largest. For other transitions the model then expects that they behave roughly like in the constant interaction model: they are the sum of the normals of the respective single-electron transitions (and thus they are affected by the added error terms as well). Errors in normals are typically not so important for these facets. As they are smaller, estimation errors in the normal do not amount to relevant changes in the polytope, and it is known that already in perfect simulated devices that completely follow the constant interaction model, the normals of these transitions are often estimated poorly, while still being perfectly useful for the task. However, it is still possible to add further error terms. If a single transition is assumed to have relevant size, it is possible to change the definition for this single transition by adding another error term ϵₖ:

$${f}_{k} ( υ ) = {\underbrace{{c}_{k} ( {t}_{k} TA + {t}_{k , > 0}^{T} {A}^{+} + {t}_{k , < 0}^{T} {A}^{-} + {ϵ}_{k} )}}_{{w}_{k}^{T}} υ + {b}_{k}$$

A further model example comprises guidelines as to how to modify the model in order to take into account rounding effects of the polytopes. If it is set that φ(υ)=υ, then then the learned model will still closely resemble convex polytopes, the changes of the linear terms only change the symmetry of the polytope but do not allow us to learn significantly rounded corners. While it is possible to get some effect from m(υ) with appropriately small choice of cₖ, the rounding is unguided and affects the whole length of the transition and not only the vertex. Thus, it is needed a model to adapt to significant rounding effects.

There can be various ways of handling this, but on this document the following example is disclosed. It can be considered that the coulomb diamond of interest has some center μ and as the polytope is roughly convex, all its transitions can be reached by the intersection of a line starting from μ in the direction of the transition. It can then be possible to model roundedness by a scaling factor that scales this intersection point to align with the learned polytope in the direction. This can be modeled by choosing:

$$Φ ( υ ) = s ( \frac{υ - μ}{‖ υ - μ ‖} ) \cdot ( υ - μ ) + μ$$

If the function s(⋅)=1, then the method obtains φ(υ)=υ. Otherwise, points υ that lie on the line μ+t·p for some t>0, get scaled by some factor s(p) to the position υ′=μ+ts(p)·p. The effect is that the convex polytope gets warped. The function s can be any machine-learning model that can accept vectors of length 1. This could for example be neural networks or kernel expansion models.

### An Example for Fitting the Model to Data

A fitting example can comprise a model that uses regularized maximum likelihood fitting. While in prior art documents, the role of regularization is mostly to ensure that the optimizer does not get stuck in inferior local optima, regularization now becomes an important aspect of model fitting. The parametrization introduced in the previous examples is not unique. There are now three matrices, A, A⁺ and A⁻ that broadly have the same role. For example, as A=∧Γ, the unregularised optimizer could set ∧=0 and set A⁺=A⁻=Γ. More importantly, this would allow the algorithm to learn choices of parameters that forget the initial hard-coded connection between transition labels tₖ and normal of learned transitions. Similarly, the model s left unregularised can try to bend single transitions to cover multiple transitions in space. Both failure conditions need to be prevented.

Therefore, an example of an algorithm assumes that data is supplied in pairs υ⁺, υ⁻ where samples belonging to υ⁺ are considered as being inside the polytope, while samples υ⁻ are outside.

$${max}_{c , A , b , {A}^{+} , {A}^{-} , α} - {Ω}_{1} ( c , A ) - {Ω}_{2} ( {A}^{+} , {A}^{-} , α ) + {\sum }_{i = 1}^{ℓ} {L}^{-} ( h ( {v}_{i}^{-} ) ) + {L}^{+} ( h ( {v}_{i}^{+} ) ) ,$$

Under the constraints that cᵢᵢ>0, ∧ᵢᵢ>0 and Ω₁ and Ω₂ are regularization terms, as defined below. The function L⁺ and L⁻ are loss terms that penalize wrongly estimating the correct class. In this example the logistic loss function is used.

The regulariser Ω₁ can be the same as used in the prior art:

$${Ω}_{1} ( c , Λ ) = {\sum }_{i = 1}^{M} {λ}_{1} {δ}^{2} {‖ {c}_{ii} {t}_{i}^{T} ΛΓ ‖}^{2} + {\sum }_{j = 1}^{N} {λ}_{2} {log}^{2} ( {Λ}_{jj} )$$

Where λ₁, λ₂, are regularization strength parameters and Ω₂ is defined as

$${Ω}_{2} ( {A}^{+} , {A}^{-} , α ) = {λ}_{3} ( {\sum }_{i , j}^{M , N} {( {A}_{i , j}^{+} )}^{2} + {( {A}_{i , j}^{-} )}^{2} ) + {λ}_{4} {\sum }_{i} ‖ {v}_{i}^{-} - Φ ( {v}_{i}^{-} ) ‖ .$$

Here, λ₃, λ₄ are regularisation strength parameters that need to be tuned. The first term penalizes large values in the error terms A⁺ and A⁻, preventing the first error condition. The second term penalizes that φ largely warps the space in the direction of a sample. Only small deviations are allowed. The use of the norm encourages the solution to favour sparce solutions with s(p)=1 and thus most of the modeling is done by the linear term.

With these terms in place, the model is fit to the data by solving the optimization problem. In this example, the method uses LBFGS and encode the positivity constraints by an exponential encoding, e.g., by setting cᵢᵢ=exp(yi) to remove the constraints.

### Automatic Identification of Transitions

The overall algorithms proceeds again similar to the previous cited work. As a primitive, the algorithm relies on the presence of a linesearch algorithm that is able to produce point pairs ν⁺, ν⁻ along a ray μ+tp, t>0 such that a transition lies in between the two points, as discussed in the model fitting section. It is assumed that the user can provide an estimate of the line search precision ∥ν⁺−ν⁻∥<δ to control the hyper parameters of the device.
1. The method begins with an initial Dataset containing random voltage point pairs ν⁺, ν⁻. The method may create this dataset by taking a user supplied point μ₀ that lies within the coulomb diamond. The method may then proceed to create line searches in random directions around that point. The data may then be used to compute a better estimate for the middle of the polytope, via

$$μ = \frac{1}{l} {\sum }_{i = 1}^{l} {v}^{-} .$$

This may be the centroid from which all future line searches are starting and also the point used for φ in the model.
2. The model may then be fit using the methodology outlined before.
3. New data may be acquired using the procedure described below in the section “acquisition of data”. Since the nonlinear parts of the disclosed method only warps the direction from the centroid, the computed search directions are unaffected.
4. The new data may be added to the dataset and the stopping criterion may be computed with the process described below in the section “Stop criterion”. If the algorithm does not stop, the algorithm may continue with step 2, otherwise step 5 may be executed.
5. After training is done, the algorithm may identify for each transition a point on the transition that allows executing the transition. Here, the method may pick as an initial point the mean (or median) of the point pairs that the algorithm identified in step 4 to be separated by a given boundary. The transition can be queried by performing a voltage ramp from p through the identified point to the target neighboring state.

As a proof of concept, the method simulated a series of devices without tunneling and executed the algorithm on the simulation, hardcoding Φ(ν)=ν, i.e., fixing αᵢ=0. In the presented data, the algorithm performed successfully and a visualization of a run on a double-dot device is shown in FIG. 2.

### Acquisition of Data

There is a large variation of the size and surface area of facets in a Coulomb diamond.

Thus, it is unlikely that the method obtains enough samples for each facet using random sampling alone. Instead, for general Pₙ, the method will obtain new measurements by constructing points for each candidate facet of our learned estimate \tilde{P}ₙ, through which the method performs a line-search. To do this, the method has to handle first that it only have learned a probabilistic model for \tilde{P}ₙ. Not all possible candidates of transitions tₖ have enough evidence in the model, which is represented by a small ∥Wₖ∥. These facets might not exist, or there is not enough evidence in the dataset to support them. In both cases, the model will likely move the facets outside the polytope. The approach is to take these facets, treat them as existing and move them back inside the polytope.

This will likely generate an additional facet to sample new candidate points from. If the facet does not exist, these points will result in the facet being pushed further away, until eventually it can only be placed in a corner of the model, which rules it out.

This can be formalized as follows: If ∥Wₖ∥≥0.1/δ, the method assumes that there is sufficient evidence for it in the model and add the linear equation

$${W}_{k}^{T} v + {b}_{k} \leq 0 to {\tilde{P}}_{n} .$$

If ∥Wₖ∥<0.1/δ, the method adds a replacement facet

$${\tilde{W}}_{k}^{T} v + {\tilde{b}}_{k} \leq 0 with {\tilde{W}}_{k} = {W}_{k} and {\tilde{b}}_{k} = {max}_{i}^{l} {\tilde{W}}_{k}^{T} {v}_{i}^{-} .$$

This moves the facet as much inside the polytope as possible without miss-classifying a point that is known to be inside νᵢ.

Afterwards, the method can sample points on each facet in \tilde{P}ₙ by handling two cases:
The facet belonging to transition tₖ intersects with the polytope \tilde{P}ₙ in more than one point. In this case, the method can compute the largest inscribed hypersphere on the facet (as described below in the section “Computing the largest inscribed hypersphere”) in \tilde{P}ₙ as a lower bound on the surface area covered by it. the method then samples three points within the hypersphere uniformly at random. Sampling multiple points allows to quickly find enough points supporting a small facet in order to fulfil our stopping criterion, as described below in the section “Stop criterion”. If a facet is already supported by a large number of point pairs, the method skips sampling from it in order to save measurement time.
The facet belonging to tₖ does intersect with \tilde{P}ₙ in at most a single point. In this case, the method cannot sample from the inscribed hypersphere, as the facet does not exist. Instead, the method will find the closest point ν└\tilde{P}ₙ to the facet and select it as candidate. This point is the solution of the LP

$${max}_{x} {W}_{k}^{T} v$$

such that ν∈\tilde{P}ₙ∧νᵢ≥lᵢ, i=1, . . . , G where Wₖ is the normal of the facet belonging to tₖ in \tilde{P}ₙ and lᵢ the lower-bound in the i-th gate voltage.

For each of these candidate points the method conducts a line-search starting from an estimated mid-point of the polytope through the sampled points on the boundary. Each line-search returns another pair (ν⁻, ν⁺) that the method adds to the dataset. To prevent that multiple copies of similar points are added to the dataset, the method will add new points only if there are no points in the dataset within a distance of δ/4.

### Stop Criterion

The stopping criterion of the algorithm is based on a check that for all facets the algorithm found, the method either established that the facet is correct, or that it is too small to be estimated reliably with the line-search precision available.

The method bases the check for correctness of a facet on the fact that a plane in G dimensions can be uniquely defined via G linearly independent points it passes through. The line-search procedure however, does not produce single points, but point pairs

$$( {v}_{i}^{-} , {v}_{i}^{+} ) ,$$

bounding the transitions of the polytope. While a single plane can pass through multiple points between a point-pair, finding more than G point-pairs that are separated by the plane gives strong evidence that the facet found by the algorithm is real and that its parameters are correct.

If the facet is small in some direction, the limited precision of the line-search might make it impossible to reliably estimate its parameters or even disprove its existence. Thus, for each facet, the method computes the radius r of the largest inscribed hypersphere (see section “Computing the largest inscribed hypersphere” below). the method only considers correctness of equations belonging to facets with radius r>rₘᵢₙ and consider facets smaller than that as undecided: the algorithm returns them, but does not claim that they are correct. In this work and evaluation, the method considers these facets as non-existing/not found.

In the present implementation, the method chose rₘᵢₙ=2δ. Then, for facets with r>rₘᵢₙ, the method computes the number of point pairs in the dataset separated by them. A facet with parameters w, b separates a point pair (ν⁻, ν⁺) if it holds W^{T}ν⁻+b<0 and W^{T}ν⁺+b>0. the method considers a facet correct if more than G+3 point pairs fulfil this condition.

To summarize, the stopping criterion of our algorithm is that for each facet of the polytope P, either r<rₘᵢₙ or it separates more than G+3 point pairs.

### Computing the Largest Inscribed Hypersphere

Given a G dimensional polytope P with linear inequalities

$${\tilde{W}}_{k}^{T} v + {\tilde{b}}_{k} \leq 0 , k = 1 , … , M ,$$

the largest inscribed hypersphere B(m, r)={x|∥x−m∥≤r} with radius r and midpoint m is the solution of the problem

$${max}_{r , m} r ,$$

such that x∈P, ∀x∈B(m, r) ∧r>0.

It can be computed as a solution to the equivalent LP

$${max}_{r , m} r ,$$

such that

$${W}_{k}^{T} v + {b}_{k} + ‖ {W}_{k} ‖ r \leq 0 , k = 1 , … , M .$$

In our application, the method needs to compute the largest inscribed hypersphere on the i-th facet of P, which is a G−1 dimensional object. To do this, the method first computes the polytope of the facet

$${f}_{i} = \{ x ∈ P \vert {W}_{i}^{T} x + {b}_{i} = 0 \}$$

and find a G−1 dimensional coordinate representation for fᵢ, before the method can compute the largest inscribed hypersphere. For this, the method first computes a rotation matrix Q, so that

$${W}_{i}^{T} Q = ( 0 , … , 0 , ‖ {W}_{i} ‖ ) ,$$

which can be achieved by defining Q as a householder reflection.

With this, the method can substitute coordinates x=Qz, and obtain as the equality constraint of the ith facet

$${W}_{i}^{T} x + {b}_{i} = {W}_{i}^{T} Qz + {b}_{i} = ‖ {W}_{i} ‖ zG + {b}_{i} = 0.$$

Thus, in this coordinate system, the method obtains immediately that z_{G}=−bᵢ/∥Wᵢ∥. This allows to obtain the G−1 dimensional description, by rewriting fi in terms of the coordinates in z and removing the coordinate z_{G}

$${\tilde{f}}_{i} = \{ \tilde{z} ∈ {ℝ}^{G - 1} \vert {\sum }_{j = 1}^{G - 1} ( {W}_{k} Q ) {}_{j} {\tilde{z}}_{j} + {b}_{k} - {( {W}_{k} Q )}_{G} \frac{{b}_{i}}{‖ {W}_{i} ‖} \leq 0 , k \neq i \}$$

With this representation, it is possible to compute the solution of the G−1 dimensional inscribed hypersphere problem. And for any point \tilde{z} in the inscribed sphere the corresponding G dimensional coordinate becomes

$$x = {Q ( \tilde{z} , - \frac{{b}_{i}}{‖ {W}_{i} ‖} )}^{T} .$$

### Items

1. A computer implemented method for determining boundary locations of a phase state in a charge stability diagram of capacitively coupled quantum dots, comprising the steps of
   applying a first voltage vector in the charge stability diagram generated by the coupled quantum dots for defining a first phase state of the coupled quantum dots,
   determining a phase transition location of the coupled quantum dots from the first phase state to a neighboring second phase state in the charge stability diagram by varying the voltage vector for changing energy levels of the states of the quantum dots until a phase transition occurs,
   repeating steps a) and b) for at least a second voltage vector, and
   fitting the phase transition locations to a plurality of sets of fitting parameters for determining boundary location(s) of the phase state.
2. The method according to item 1, wherein the first voltage vector is applied for defining a first initial random voltage point sampled inside the first phase state such as a phase state (0,0).
3. The method according to any one of the preceding items, wherein the second voltage vector is applied for defining a second initial random voltage point sampled inside the first phase state.
4. The method according to any one of the preceding items, wherein the step of varying the voltage vector is applied varying one voltage component of the voltage vector in the charge stability diagram.
5. The method according to any one of the preceding items, wherein components of the voltage vector are voltages of a plurality of electrodes that control and define the capacitively coupled quantum dots.
6. The method according to any one of the preceding items, wherein the steps a) and b) are performed at least 10 times, preferably at least 50 times, more preferably at least 200 times.
7. The method according to any one of the preceding items, wherein the steps a) and b) are performed in an initial random voltage points located at a second phase state in the charge stability diagram.
8. The method according to any one of the preceding items, wherein a differential conductance is less than 20% of 2e²/h inside the first phase state or the second phase state in the charge stability diagram.
9. The method according to any one of the preceding items, wherein a differential conductance is at least 70% of 2e²/h during a phase transition from the first phase state or from the second phase state in the charge stability diagram.
10. The method according to any one of the preceding items, wherein the ratio between the differential conductance inside the first or the second phase state and the differential conductance during a phase transition from the first phase state or from the second phase state is less than 0.8, preferably less than 0.6, more preferably less than 0.4, even more preferably less than 0.1, most preferably around 0.05.
11. The method according to any one of the preceding items, wherein at least one set of the plurality of sets of fitting parameters is a set of linear fitting parameters.
12. The method according to item 11, wherein the step of fitting the at least one set of linear fitting parameters is provided by means of a machine learning model.
13. The method according to item 12, wherein the machine learning model is trained with training data.
14. The method according to item 13, wherein the training data comprises locations and/or orientations of phase transitions of known charge stability diagrams.
15. The method according to any one of items 11-14, wherein the machine learning model is configured to calculate differences between measured locations and measured orientations of phase transitions and locations and orientations of phase transitions of an ideal constant interaction model of a capacitively coupled quantum dot system.
16. The method according to any one of items 11-15, wherein the machine learning model is configured to calculate deviations between measured phase transition boundaries and phase transition boundaries calculated by the ideal constant interaction model of a capacitively coupled quantum dot system.
17. The method according to any one of the preceding items, wherein the at least one set of the linear fitting parameters describe the boundary location of the phase state for an electron addition in the first phase state into the neighboring phase state.
18. The method according to any one of the preceding items, wherein the at least one set of the linear fitting parameters describe the boundary location of the phase state for an electron removal from the first phase state.
19. The method according to any one of the preceding items, wherein at least one set of the linear fitting parameters describe the boundary location of the phase state for transporting an electron from one of the coupled quantum dots to the other coupled quantum dot.
20. The method according to any one of the preceding items, wherein at least one set of the plurality of sets of fitting parameters is a set of non-linear fitting parameters.
21. The method according to item 20, wherein the at least one set of non-linear fitting parameters is extracted by means of a machine learning model and/or a non-linear model, such as a deep neural network.
22. The method according to any one of items 20-21, wherein the at least one set of non-linear fitting parameters determine the boundary location(s) of the phase state.
23. The method according to any one of items 20-22, wherein the non-linear fitting parameters accommodate tunneling effects between coupled quantum dots.
24. The method according to any one of the preceding items, wherein the boundary locations reconstruct a fitted polytope and state labels of the capacitively coupled quantum dot devices according to the fitted sets of fitting parameters.
25. The method according to any one of the preceding items, wherein a voltage line-scan is performed after determining the phase transition location of the phase state into a neighboring phase state.
26. The method according to item 25, wherein the voltage line-scan is performed until a new boundary location of the phase state is measured.
27. The method according to any one of the preceding items, wherein the fitting and reconstruction of the phase state is performed starting at a midpoint of the line-scan.
28. The method according to any one of the preceding items, wherein the fitted polytope has a dimension>3.
29. A computer program comprising instructions which, when the program is executed by a computing device or a system, cause the computing device or the system to carry out any one of the steps of the method of any one of the preceding items.
30. A computer-readable medium comprising stored instructions which, when executed by a computing device or a system, cause the computing device or the system to carry out any one of the steps of the method of any one of the preceding items 1-28.
31. A system for determining boundary locations of a phase state in a charge stability diagram of capacitively coupled quantum dots, the system comprising a processor and a memory and being configured to carry out any one of the steps of the GC 20 method of any one of the preceding items [symbol]
32. A system for determining boundary locations of a phase state in a charge stability diagram of capacitively coupled quantum dots, the system comprising a plurality of sources, such as voltage sources, for controlling a plurality of electrodes connected to the capacitively coupled quantum dots, wherein the system is configured to
   apply a first voltage vector in the charge stability diagram generated by the coupled quantum dots for defining a first phase state of the coupled quantum dots,
   determine a phase transition location of the coupled quantum dots from the first phase state to a neighboring second phase state in the charge stability diagram by varying the voltage vector for changing energy levels of the states of the quantum dots until a phase transition occurs,
   repeat the steps a) and b) for at least a second voltage vector, and
   fit the phase transition locations to a plurality of sets of fitting parameters for determining boundary location(s) of the phase state.
33. The system according to item 32, wherein the system is connected to a cryostat for accommodating the coupled quantum dots and the plurality of electrodes.
34. The system according to any one of the items 32-33, wherein the plurality of sources are selected from the group of: voltage sources, current sources, or radio-frequency sources.
35. The system according to any one of the items 33-34, wherein the cryostat comprises a temperature control channel and a magnet, the magnet configured to generate a magnetic field, wherein the system is configured to control the temperature control channel and the magnet.
36. The system according to any one of the items 32-35, wherein the system is configured for automatically controlling the signals to the plurality of electrodes of the cryostat for defining and controlling the plurality of coupled quantum dots, thereby enabling automatic determination of boundary locations of a phase state in a charge stability diagram.
37. The system according to any one of the items 32-36, wherein the system is configured to carry out any one of the steps of the method of any one of the preceding items 1-28.

1. A computer implemented method for determining boundary locations of a phase state in a charge stability diagram of capacitively coupled quantum dots, comprising the steps of
a. applying a first voltage vector in the charge stability diagram generated by the coupled quantum dots for defining a first phase state of the coupled quantum dots,
b. determining a phase transition location of the coupled quantum dots from the first phase state to a neighboring second phase state in the charge stability diagram by varying the voltage vector for changing energy levels of the states of the quantum dots until a phase transition occurs,
c. repeating steps a) and b) for at least a second voltage vector, and
d. fitting the phase transition locations to a non-linear function utilizing a plurality of sets of fitting parameters for determining boundary location(s) of the phase state, wherein at least one set of the plurality of sets of fitting parameters is a set of non-linear fitting parameters extracted by means of a machine learning model, wherein the non-linear function comprises non-linear parameters, and wherein the at least one set of non-linear fitting parameters and the non-linear function determine the boundary location(s) of the phase state and fit at least one curved boundary location of the phase state, thereby accommodating significant tunneling effects between coupled quantum dots.

2. The method according to claim 1, wherein at least one set of the plurality of sets of fitting parameters is a set of linear fitting parameters.

3. The method according to claim 2, wherein the machine learning model is trained with training data, wherein the training data comprises locations and/or orientations of phase transitions of known charge stability diagrams.

4. The method according to claim 2, wherein the machine learning model is configured to calculate differences between measured locations and measured orientations of phase transitions and locations and orientations of phase transitions of an ideal constant interaction model of a capacitively coupled quantum dot system.

5. The method according to claim 2, wherein the machine learning model is configured to calculate deviations between measured phase transition boundaries and phase transition boundaries calculated by the ideal constant interaction model of a capacitively coupled quantum dot system.

6. The method according to claim 1, wherein components of the voltage vector are voltages of a plurality of electrodes that control and define the capacitively coupled quantum dots.

7. The method according to claim 2, wherein the at least one set of the linear fitting parameters describe the boundary location of the phase state for an electron addition in the first phase state into the neighboring phase state.

8. The method according to claim 1, wherein the boundary locations reconstruct a fitted polytope and state labels of the capacitively coupled quantum dot devices according to the fitted sets of fitting parameters.

9. The method according to claim 1, wherein a voltage line-scan is performed after determining the phase transition location of the phase state into a neighboring phase state.

10. The method according to claim 1, wherein the ratio between the differential conductance inside the first or the second phase state and the differential conductance during a phase transition from the first phase state or from the second phase state is less than 0.8, or less than 0.6, or less than 0.4, or less than 0.1, or around 0.05.

11. The method according to claim 1, wherein the fitted polytope has a dimension>3.

12. A computer program comprising instructions which, when the program is executed by a computing device or a system, cause the computing device or the system to carry out the steps of the method according to claim 1.

13. A computer-readable medium comprising stored instructions which, when executed by a computing device or a system, cause the computing device or the system to carry out the steps of the method of claim 1.

14. A system for determining boundary locations of a phase state in a charge stability diagram of capacitively coupled quantum dots, the system comprising a processor and a memory and being configured to carry out the steps of the method of claim 1.

15. A system for determining boundary locations of a phase state in a charge stability diagram of capacitively coupled quantum dots, the system comprising a plurality of sources, such as voltage sources, for controlling a plurality of electrodes connected to the capacitively coupled quantum dots, wherein the system is configured to
a. apply a first voltage vector in the charge stability diagram generated by the coupled quantum dots for defining a first phase state of the coupled quantum dots,
b. determine a phase transition location of the coupled quantum dots from the first phase state to a neighboring second phase state in the charge stability diagram by varying the voltage vector for changing energy levels of the states of the quantum dots until a phase transition occurs,
c. repeat the steps a) and b) for at least a second voltage vector, and
d. fit the phase transition locations to a non-linear function utilizing a plurality of sets of fitting parameters for determining boundary location(s) of the phase state, wherein at least one set of the plurality of sets of fitting parameters is a set of non-linear fitting parameters extracted by means of a machine learning model, such as a deep neural network, wherein the non-linear function comprises non-linear parameters, and wherein the at least one set of non-linear fitting parameters and the non-linear function determine the boundary location(s) of the phase state and fit at least one curved boundary location of the phase state, thereby accommodating significant tunneling effects between coupled quantum dots.

16. The system according to claim 15, wherein the system is connected to a cryostat for accommodating the coupled quantum dots and the plurality of electrodes.

17. The system according to claim 15, wherein the plurality of sources are selected from the group of: voltage sources, current sources, or radio-frequency sources.

18. The system according to claim 16, wherein the cryostat comprises a temperature control channel and a magnet, the magnet configured to generate a magnetic field, wherein the system is configured to control the temperature control channel and the magnet to fit the phase transition locations of a coupled quantum dot, and correlate the changes of the charge stability diagram to the changes of the temperature and/or magnetic field.

19. The system according to claim 16, wherein the system is configured for automatically controlling the signals to the plurality of electrodes of the cryostat for defining and controlling the plurality of coupled quantum dots, thereby enabling automatic determination of boundary locations of a phase state in a charge stability diagram.

20. The system according to claim 15, wherein the system is configured to carry out a computer implemented method for determining boundary locations of a phase state in a charge stability diagram of capacitively coupled quantum dots, comprising the steps of
a. applying a first voltage vector in the charge stability diagram generated by the coupled quantum dots for defining a first phase state of the coupled quantum dots,
b. determining a phase transition location of the coupled quantum dots from the first phase state to a neighboring second phase state in the charge stability diagram by varying the voltage vector for changing energy levels of the states of the quantum dots until a phase transition occurs,
c. repeating steps a) and b) for at least a second voltage vector, and
d. fitting the phase transition locations to a non-linear function utilizing a plurality of sets of fitting parameters for determining boundary location(s) of the phase state, wherein at least one set of the plurality of sets of fitting parameters is a set of non-linear fitting parameters extracted by means of a machine learning model, such as a deep neural network, wherein the non-linear function comprises non-linear parameters, and wherein the at least one set of non-linear fitting parameters and the non-linear function determine the boundary location(s) of the phase state and fit at least one curved boundary location of the phase state, thereby accommodating significant tunneling effects between coupled quantum dots.
